(19) United States
(12) Patent Application Publication
(10) Pub. No.: US 2026/0352055 A1
(43) Pub. Date: Nov. 5, 2026

(54) MOTOR

(71) Applicant: NIDEC CORPORATION, Kyoto (JP)

(72) Inventors: Takahiro HISADA, Kyoto (JP); Tomoki NAKATSU, Kyoto (JP); Tatsuhiko ASANO, Kyoto (JP)

(21) Appl. No.: 19/719,629

(22) Filed: Jun. 25, 2026

Related U.S. Application Data
(63) Continuation of application No. PCT/JP2024/041536, filed on Nov. 22, 2024.

(30) Foreign Application Priority Data
Dec. 28, 2023 (JP) 2023-222683

(51) Int. Cl. H02K 3/52

(52) U.S. Cl. CPC H02K 3/522; H02K 2203/09

(57) ABSTRACT

A motor includes a rotor, a stator radially outside the rotor, and a bus bar assembly on one axial side of the stator. An insulator of the stator includes an inner insulator portion radially inside the coil. The bus bar assembly includes a bus bar and a bus bar holder holding the bus bar and including a holder main body portion. The bus bar includes a coil connection portion connected to the coil. The coil connection portion protrudes radially outward from the holder main body portion. A recess is provided in one of the inner insulator portion and the bus bar holder and a projection is provided on the other of the inner insulator portion and the bus bar holder. At least a portion of the projection is inserted into the recess. The bus bar holder is supported by the inner insulator portion in an axial direction.

### CROSS-REFERENCE TO RELATED APPLICATIONS

This application is a continuation of International Application No. PCT/JP 2024/041536, filed on Nov. 22, 2024, which is incorporated herein by reference in its entirety, and which claims priority to Japanese Patent Application No. 2023-222683, filed in Japan on Dec. 28, 2023, the entire contents of which are incorporated herein by reference.

### FIELD OF THE INVENTION

The present disclosure relates to motors.

### BACKGROUND

There is known a motor including a resin mold body that holds a bus bar.

In the motor described above, for example, in order to facilitate a connection operation between the bus bar and a coil, a structure is sometimes adopted in which a portion of the bus bar that is connected to the coil protrudes radially outward from a bus bar holder such as the above-mentioned resin mold body. When such a structure is adopted, a leg portion that protrudes radially outward may be provided at the bus bar holder, and the bus bar holder may be supported, via the leg portion, on a radially outer portion of an insulator in a stator. However, in this case, there are situations where it becomes difficult to stably support the bus bar holder relative to the stator.

### SUMMARY

A motor according to an example embodiment of the present disclosure includes a rotor that is rotatable about a center axis line, a stator that is positioned radially outside the rotor, and a bus bar assembly that is positioned on a first axial side of the stator. The stator includes a stator core, an insulator that is attached to the stator core, and a coil that is attached to the stator core via the insulator. The insulator includes an inner insulator portion that is positioned radially inside the coil. The bus bar assembly includes a bus bar and a bus bar holder that holds the bus bar. The bus bar holder includes a holder main body portion that has an annular shape surrounding the center axis line. The bus bar includes a coil connection portion that is connected to a coil lead wire drawn out from the coil. The coil connection portion protrudes radially outward from the holder main body portion. A portion of one of the inner insulator portion and the bus bar holder includes a first recess portion. A portion of the other of the inner insulator portion and the bus bar holder includes a first projection portion. At least a portion of the first projection portion protrudes into the first recess portion. The bus bar holder is supported by the inner insulator portion in an axial direction.

The above and other elements, features, steps, characteristics and advantages of the present disclosure will become more apparent from the following detailed description of example embodiments with reference to the attached drawings.

### BRIEF DESCRIPTION OF THE DRAWINGS

FIG. 1 is a cross-sectional view illustrating a motor in a first example embodiment of the present invention.

FIG. 2 is a view of a stator and a bus bar assembly in the first example embodiment as viewed from above.

FIG. 3 is a perspective view illustrating a portion of an insulator and a portion of a bus bar holder in the first example embodiment.

FIG. 4 is a cross-sectional view illustrating a portion of the motor in the first example embodiment.

FIG. 5 is a perspective view illustrating a portion of the bus bar holder in the first example embodiment.

FIG. 6 is a cross-sectional view illustrating a portion of a motor in a second example embodiment of the present invention.

FIG. 7 is a perspective view illustrating a portion of an insulator and a portion of a bus bar holder in the second example embodiment.

FIG. 8 is a cross-sectional view illustrating a portion of a motor in a third example embodiment of the present invention.

FIG. 9 is a perspective view illustrating a portion of an insulator in the third example embodiment.

FIG. 10 is a perspective view illustrating a portion of a bus bar holder in the third example embodiment.

FIG. 11 is a cross-sectional view illustrating a portion of a motor in a fourth example embodiment of the present invention.

FIG. 12 is a perspective view illustrating a portion of an insulator in the fourth example embodiment.

FIG. 13 is a perspective view illustrating a portion of a bus bar holder in the fourth example embodiment.

FIG. 14 is an exploded perspective view illustrating a portion of a motor in a fifth example embodiment of the present invention.

### DETAILED DESCRIPTION

In each of the drawings, a center axis line J in a motors of example embodiments described below is illustrated in an imaginary manner. In the following description, unless otherwise noted, an axial direction of the center axis line J is simply called an “axial direction”, a radial direction centered on the center axis line J is simply called a “radial direction”, and a circumferential direction centered on the center axis line J is simply called a “circumferential direction”. A Z axis illustrated in each of the drawings indicates a direction in which the center axis line J extends. In the following description, a side in the axial direction toward which an arrow of the Z axis points (+Z side) is called an “upper side”, and a side in the axial direction opposite to the side toward which the arrow of the Z axis points (−Z side) is called a “lower side”.

In the following example embodiments, the upper side corresponds to an “one axial side” or “a first axial side”, and the lower side corresponds to “the other axial side” or “a second axial side”. The upper side and the lower side are merely names for describing the relative positional relationship of each portion, and the actual arrangement relationship and the like may be an arrangement relationship and the like other than the arrangement relationship and the like indicated by these names.

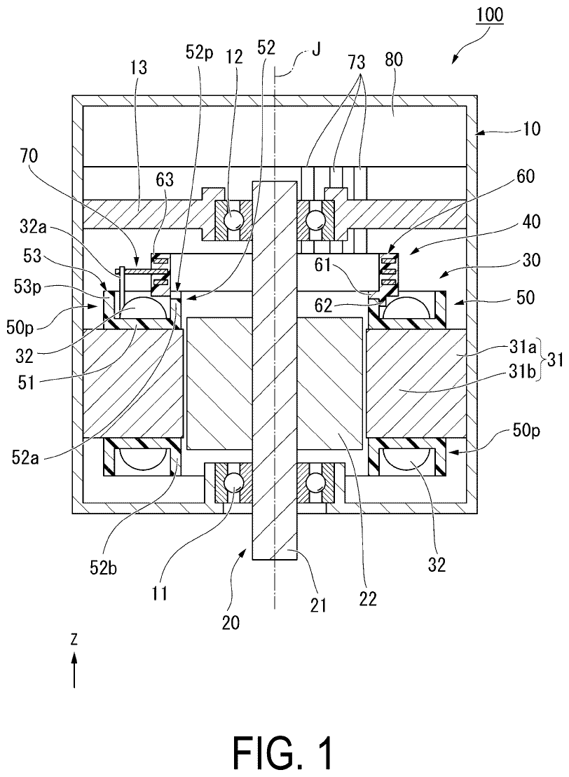

As illustrated in FIG. 1, a motor 100 of the present example embodiment includes a housing 10, a rotor 20, a stator 30, a bus bar assembly 40, and a control device 80. The housing 10 accommodates the rotor 20, the stator 30, the bus bar assembly 40, and the control device 80 inside. The rotor 20 is rotatable about the center axis line J. The rotor 20 includes a shaft 21 and a rotor main body 22. The shaft 21 has a columnar shape extending in the axial direction centered on the center axis line J. The shaft 21 is rotatably supported about the center axis line J by a pair of bearings 11 and 12. The bearing 11 is held by a lower wall portion of the housing 10. The bearing 12 is held by a bearing holder 13 provided in the housing 10. The bearing holder 13 is positioned above the stator 30 and the bus bar assembly 40, and is positioned below the control device 80. The rotor main body 22 is fixed to an outer circumferential surface of the shaft 21. Although omitted in illustration, the rotor main body 22 includes a rotor core fixed to the shaft 21 and a magnet held by the rotor core.

The stator 30 is positioned radially outside the rotor 20. The stator 30 has an annular shape surrounding the rotor 20. In the present example embodiment, the stator 30 has a substantially annular shape centered on the center axis line J. The stator 30 includes a stator core 31, an insulator 50, and a coil 32.

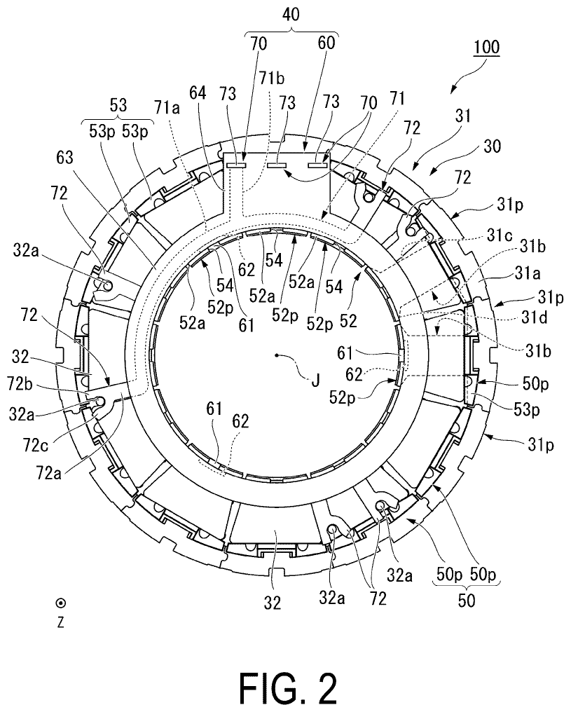

The stator core 31 includes a core back 31a and a plurality of teeth 31b. As illustrated in FIG. 2, the core back 31a has an annular shape surrounding the center axis line J. In the present example embodiment, the core back 31a has a substantially annular shape centered on the center axis line J. The plurality of teeth 31b extend radially inward from the core back 31a. The plurality of teeth 31b are arranged with a gap in between in the circumferential direction. More specifically, the plurality of teeth 31b are arranged at an equal interval over the entire circumference in the circumferential direction. Each of the teeth 31b includes a tooth main body portion 31c and an umbrella portion 31d. The tooth main body portion 31c extends radially inward from a radially inner surface of the core back 31a. The umbrella portion 31d is continuous with the radially inner end portion of the tooth main body portion 31c. The umbrella portion 31d protrudes to both sides in the circumferential direction from the tooth main body portion 31c. A radially inner surface of the umbrella portion 31d corresponds to a radially inner surface of the tooth 31b, and faces a radially outer surface of the rotor main body 22 via a gap in the radial direction.

In the present example embodiment, the stator core 31 is formed in an annular shape by circumferentially connecting a plurality of core piece portions 31p that are divided in the circumferential direction. Each of the plurality of core piece portions 31p includes a circumferential portion of the core back 31a and one tooth 31b.

The insulator 50 is attached to the stator core 31. The insulator 50 is a member having insulating properties. In the present example embodiment, the insulator 50 is formed of a resin. In the present example embodiment, the insulator 50 includes a plurality of insulator piece portions 50p. The plurality of insulator piece portions 50p are arranged to be arrayed in the circumferential direction. The plurality of insulator piece portions 50p are arranged at an equal interval over the entire circumference in the circumferential direction. The plurality of insulator piece portions 50p are attached to the plurality of teeth 31b, respectively. In the present example embodiment, the plurality of insulator piece portions 50p are separate bodies independent from each another. The plurality of insulator piece portions 50p may be coupled to each other in the circumferential direction. Although omitted in illustration, each of the insulator piece portions 50p is formed by two members that are divided in the axial direction. For example, the two members are members having the same shape, and are arranged in the axial direction with their orientations reversed relative to each other.

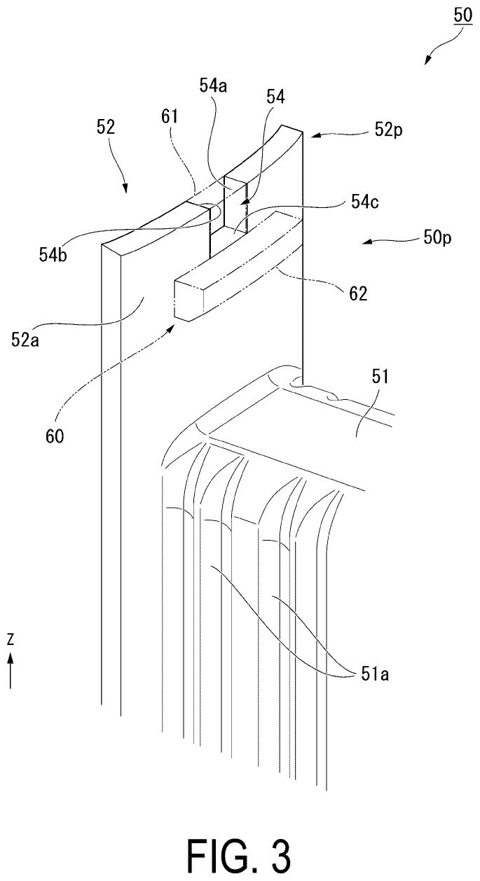

As illustrated in FIG. 1, each of the plurality of insulator piece portions 50p includes a tooth cover portion 51, an inner wall portion 52p, and an outer wall portion 53p. The tooth cover portion 51 is attached to the tooth 31b. The tooth cover portion 51 covers the tooth 31b from both sides in the axial direction and both sides in the circumferential direction. The tooth cover portion 51 has a substantially tubular shape surrounding the tooth 31b about the axis line extending in a direction the tooth 31b extends. The coil 32 is attached to the tooth cover portion 51. As illustrated in FIG. 3, a groove portion 51a extending in the axial direction is provided in a side surface of the tooth cover portion 51 in the circumferential direction. A plurality of guide grooves 51a are provided to be arrayed in the radial direction in each of both side surfaces of the tooth cover portion 51 in the circumferential direction.

As illustrated in FIG. 1, the inner wall portion 52p is continuous with the radially inner end portion of the tooth cover portion 51. The inner wall portion 52p is positioned radially inside the coil 32. The inner wall portion 52p protrudes to both sides in the axial direction from the tooth cover portion 51. As illustrated in FIG. 3, the inner wall portion 52p protrudes to both sides in the circumferential direction from the tooth cover portion 51. The inner wall portion 52p has an arc shape extending in the circumferential direction as viewed in the axial direction. In the present example embodiment, the radial dimension of the inner wall portion 52p is constant throughout the circumferential direction. The radial dimension of the inner wall portion 52p may vary depending on a position in the circumferential direction. For example, the radial dimension of the inner wall portion 52p may increase as the distance from the center portion of the inner wall portion 52p in the circumferential direction increases to both sides in the circumferential direction.

As illustrated in FIG. 1, the inner wall portion 52p includes a first inner protruding portion 52a and a second inner protruding portion 52b. The first inner protruding portion 52a is a portion of the inner wall portion 52p that protrudes upward from the tooth cover portion 51. The second inner protruding portion 52b is a portion of the inner wall portion 52p that protrudes downward from the tooth cover portion 51. As illustrated in FIG. 3, in the present example embodiment, the first inner protruding portion 52a has a plate like shape having a plate surface facing in the radial direction. The first inner protruding portion 52a has an arc shape extending in the circumferential direction as viewed in the axial direction. The second inner protruding portion 52b has a shape axially symmetrical with the first inner protruding portion 52a.

As illustrated in FIG. 2, the inner wall portions 52p of the plurality of insulator piece portions 50p are arranged to be arrayed in the circumferential direction. A gap is provided between the inner wall portions 52p adjacent to each other in the circumferential direction. In the present example embodiment, the plurality of inner wall portions 52p form an inner insulator portion 52. In other words, the insulator 50 includes the inner insulator portion 52, and the inner insulator portion 52 includes each of the inner wall portions 52p of the plurality of insulator piece portions 50p. The inner insulator portion 52 is positioned radially inside the coil 32. In the present example embodiment, the inner insulator portion 52 has a substantially annular shape centered on the center axis line J.

As illustrated in FIG. 3, the inner insulator portion 52 includes a first recess portion 54. In the present example embodiment, the first recess portion 54 is provided at the upper end portion of the first inner protruding portion 52a. The first recess portion 54 is recessed downward from the upper end surface of the first inner protruding portion 52a. The first recess portion 54 passes through the first inner protruding portion 52a in the radial direction. The first recess portion 54 is opened radially inward and radially outward. The interior of the first recess portion 54 has a rectangular shape as viewed in the radial direction. In the present example embodiment, the first recess portion 54 is provided at the center portion of the first inner protruding portion 52a in the circumferential direction. The center of the first recess portion 54 in the circumferential direction is provided at the same position in the circumferential direction as the center portion of the first inner protruding portion 52a in the circumferential direction.

The inner surfaces of the first recess portion 54 include a pair of side surfaces 54a and 54b and a bottom surface 54c. The bottom surface 54c is a portion, among the inner surfaces of the first recess portion 54, that is positioned on the lower side. The bottom surface 54c faces upward. In the present example embodiment, the bottom surface 54c is a flat surface orthogonal to the axial direction. The pair of side surfaces 54a and 54b are portions, among the inner surfaces of the first recess portion 54, that are positioned on both surfaces in the circumferential direction, respectively. The pair of side surfaces 54a and 54b face in the circumferential direction. The pair of side surfaces 54a and 54b are flat surfaces orthogonal to the circumferential direction. The pair of side surfaces 54a and 54b face each other at a gap in the circumferential direction. The pair of side surfaces 54a and 54b extend upward from the respective edge portions of the bottom surface 54c on both sides in the circumferential direction. The upper end portions of the pair of side surfaces 54a and 54b are continuous with the upper end surface of the first inner protruding portion 52a. The pair of side surfaces 54a and 54b sandwich a first projection portion 61, which is described below, in the circumferential direction.

As illustrated in FIG. 2, in the present example embodiment, the first recess portion 54 is provided at the inner wall portion 52p of each of the insulator piece portions 50p. In other words, in the present example embodiment, the inner insulator portion 52 includes the plurality of first recess portions 54. The plurality of first recess portions 54 are arranged with a gap in between in the circumferential direction. The plurality of first recess portions 54 are arranged at an equal interval over the entire circumference in the circumferential direction. By providing the first recess portion 54 to each of the plurality of insulator piece portions 50p, all the plurality of insulator piece portions 50p can be formed in the same shape. Thus, unlike a case in which the plurality of insulator piece portions 50p include insulator piece portions 50p having different shapes from each another, each of the plurality of insulator piece portions 50p can be manufactured by a single type of mold. With this, the manufacturing cost of the insulator 50 can be reduced, and the manufacturing cost of the motor 100 can be reduced. There is no need to consider to which tooth 31b the insulator piece portion 50p provided with the first recess portion 54 is to be attached, and hence the assemblability of the stator 30 can be improved. The first recess portion 54 may not be provided at the inner wall portion 52p of each of the insulator piece portions 50p, and may be provided only to the insulator piece portion 50p that faces the first projection portion 61 in the axial direction, which is described below, instead.

As illustrated in FIG. 1, the outer wall portion 53p is continuous with the radially outer end portion of the tooth cover portion 51. The outer wall portion 53p is positioned radially outside the coil 32. The outer wall portion 53p protrudes to both sides in the axial direction from the tooth cover portion 51. Although omitted in illustration, the outer wall portion 53p protrudes to both sides in the circumferential direction from the tooth cover portion 51. As illustrated in FIG. 2, the outer wall portions 53p of the plurality of insulator piece portions 50p are arranged to be arrayed in the circumferential direction. A gap is provided between the outer wall portions 53p adjacent to each other in the circumferential direction. In the present example embodiment, the plurality of outer wall portions 53p form an outer insulator portion 53. In other words, the insulator 50 includes the outer insulator portion 53. The outer insulator portion 53 is positioned radially outside the coil 32. In the present example embodiment, the outer insulator portion 53 has a substantially annular shape centered on the center axis line J.

The coil 32 is attached to the stator core 31 via the insulator 50. The plurality of coils 32 are provided. The plurality of coils 32 are attached to the plurality of teeth 31b via the respective tooth cover portions 51 of the plurality of insulator piece portions 50p. Each of the coils 32 is configured by winding a conducting wire around the tooth cover portion 51 mounted on the tooth 31b. In other words, each of the coils 32 is configured by winding the conducting wire around the tooth 31b via the insulator piece portion 50p. A coil lead wire 32a is drawn out from at least one coil 32 of the plurality of coils 32. The coil lead wire 32a is configured by an end portion of the conducting wire forming the coil 32. For example, the coil lead wire 32a is drawn out upward from six coils 32.

As illustrated in FIG. 1, the bus bar assembly 40 is positioned on the upper side of the stator 30. The bus bar assembly 40 is supported from below by the stator 30. The bus bar assembly 40 includes a bus bar holder 60 and a bus bar 70.

The bus bar 70 is electrically connected to the coil 32. The bus bar 70 is a plate-like metal member. As illustrated in FIG. 2, the plurality of bus bars 70 are provided. In the present example embodiment, three bus bars 70 are provided. Each of the bus bars 70 includes a bus bar main body portion 71, a coil connection portion 72, and a terminal portion 73. The bus bar main body portion 71 is held by the bus bar holder 60. In the present example embodiment, the bus bar main body portion 71 is embedded and held in the bus bar holder 60. More specifically, the bus bar main body portion 71 is embedded and held in a holder main body portion 63, which is described below. The bus bar main body portion 71 has a plate like shape having a plate surface facing in the axial direction. The bus bar main body portion 71 includes an arc portion 71a that extends in the circumferential direction and an extending portion 71b that extends radially outward from the arc portion 71a. The respective extending portions 71b of the plurality of bus bars 70 are arranged to be arrayed in a direction orthogonal to both a direction in which a terminal holding portion 64 described below protrudes from the bus bar main body portion 71 and the axial direction.

The coil connection portion 72 is a portion to which the coil lead wire 32a drawn out from the coil 32 is connected. The coil connection portion 72 extends radially outward from the bus bar main body portion 71. More specifically, the coil connection portion 72 extends radially outward from the arc portion 71a. The coil connection portion 72 protrudes radially outward from the holder main body portion 63 described below. The coil connection portion 72 includes an arm portion 72a and a pair of nipping portions 72b and 72c. The arm portion 72a extends radially outward from the radially outer edge portion of the bus bar main body portion 71. The arm portion 72a has a plate like shape having a plate surface facing in the axial direction.

The pair of nipping portions 72b and 72c are continuous with the radially outer end portion of the arm portion 72a. The pair of nipping portions 72b and 72c face each other with a gap in between in the circumferential direction. Due to the radially outer end portion of the arm portion 72a and the pair of nipping portions 72b and 72c, the radially outer end portion of the coil connection portion 72 has a substantially U-like shape opened to the radially outer side as viewed in the axial direction. The pair of nipping portions 72b and 72c sandwich the coil lead wire 32a in the circumferential direction. For example, the pair of nipping portions 72b and 72c are connected to the coil lead wire 32a by welding. The pair of nipping portions 72b and 72c may be caulked in a direction in which the pair of nipping portions 72b and 72c approach each other in the circumferential direction while the coil lead wire 32a is sandwiched between the pair of nipping portions 72b and 72c, to come into contact with each other. In the present example embodiment, two coil connection portions 72 are provided at each of the bus bars 70. Except for a radially inner end, the coil connection portion 72 is exposed to the outside of the bus bar holder 60.

The terminal portion 73 extends upward from the bus bar main body portion 71. More specifically, the terminal portion 73 extends upward from the radially outer end portion of the extending portion 71b. The terminal portion 73 has a plate like shape having a plate surface facing in the radial direction. The terminal portion 73 protrudes upward from the terminal holding portion 64 described below. As illustrated in FIG. 1, the upper end portion of the terminal portion 73 is electrically connected to the control device 80. With this, the coil 32 and the control device 80 are electrically connected to each other via the bus bar 70. The control device 80 includes an inverter circuit that supplies power to the coil 32. Power is supplied from the control device 80 to each of the coils 32 via the bus bar 70. The terminal portion 73 passes through a hole provided in the bearing holder 13, which is omitted in illustration, in the axial direction. As illustrated in FIG. 2, the respective terminal portions 73 of the bus bars 70 are arranged to be arrayed in a direction in which the respective extending portions 71b of the bus bars 70 are arrayed.

The bus bar holder 60 holds the bus bar 70. In the present example embodiment, the bus bar holder 60 is formed of a resin. For example, the bus bar holder 60 is formed by insert molding using the bus bar 70 as an insert member. The bus bar holder 60 includes the holder main body portion 63 and the terminal holding portion 64. The holder main body portion 63 has an annular shape surrounding the center axis line J. In the present example embodiment, the holder main body portion 63 has a substantially annular shape centered on the center axis line J. As illustrated in FIG. 1, the holder main body portion 63 is positioned radially outside the inner insulator portion 52. More specifically, the lower end portion of the holder main body portion 63 is positioned radially outside the upper end portion of the inner insulator portion 52. On the radially inner side of the lower end portion of the holder main body portion 63, the upper end portion of the inner insulator portion 52 is inserted. For example, on the radially inner side of the lower end portion of the holder main body portion 63, the upper end portion of the inner insulator portion 52 is clearance-fitted.

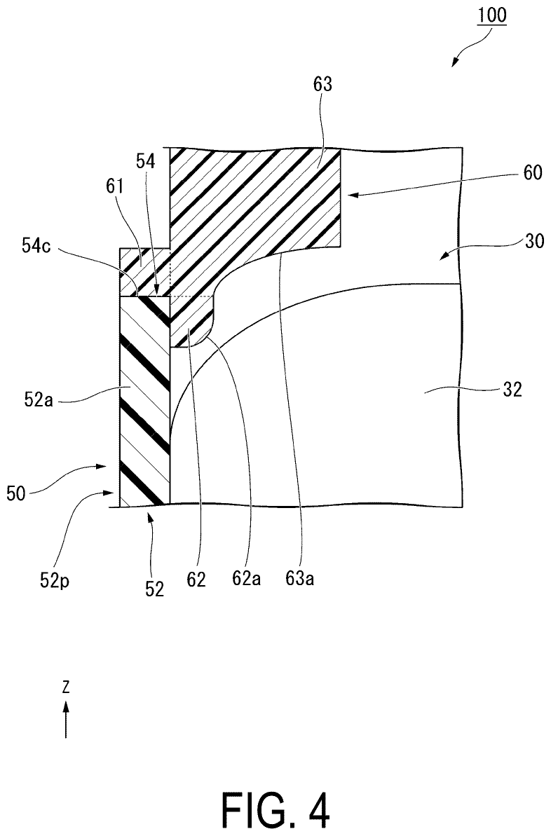

The holder main body portion 63 faces the coil 32 in the axial direction. The holder main body portion 63 is positioned on the upper side of the coil 32. As illustrated in FIG. 4, more specifically, the holder main body portion 63 is positioned on the upper side of the radially inner portion of the coil 32. A portion of the lower surface of the holder main body portion 63 is provided with a second recess portion 63a recessed to the upper side, the portion facing the coil 32 in the axial direction. By providing the second recess portion 63a, the holder main body portion 63 can be suppressed from being in contact with the coil 32. In the present example embodiment, the second recess portion 63a is provided radially outside a portion of the lower surface of the holder main body portion 63 to which a second projection portion 62 described below is provided. The face of the second recess portion 63a, which faces downward, is positioned on the upper side toward the radially outer side. The face of the second recess portion 63a, which faces downward, has a curved shape as viewed in the circumferential direction. The surface of the second recess portion 63a, which faces downward, may have a linear shape as viewed in the circumferential direction.

As illustrated in FIG. 2, the terminal holding portion 64 protrudes radially outward from the holder main body portion 63. The terminal holding portion 64 has a substantially rectangular parallelepiped shape. The terminal holding portion 64 holds the extending portion 71b and the terminal portion 73 of each of the bus bars 70. The entire extending portion 71b and the lower end portion of the terminal portion 73 are embedded and held in the terminal holding portion 64.

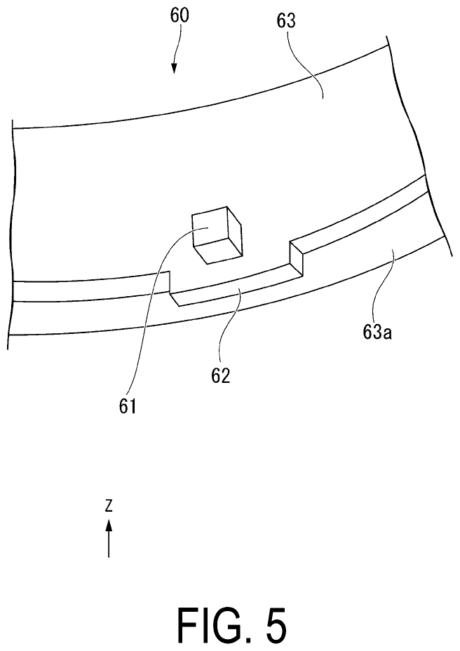

As illustrated in FIG. 5, the bus bar holder 60 includes the first projection portion 61. In the present example embodiment, the first projection portion 61 protrudes from the radially inner surface of the holder main body portion 63 to the radially inner side. The first projection portion 61 is provided at the lower end portion of the radially inner surface of the holder main body portion 63. The first projection portion 61 has a substantially rectangular parallelepiped shape. As illustrated in FIG. 3, at least a portion of the first projection portion 61 is inserted into the first recess portion 54. In the present example embodiment, the entire first projection portion 61 is inserted into the first recess portion 54. Only a portion of the first projection portion 61 may be inserted into the first recess portion 54, and the other portion of the first projection portion 61 may be provided outside the first recess portion 54. The first projection portion 61 is in contact with the bottom surface 54c. With this, the bus bar holder 60 is supported by the inner insulator portion 52 via the first projection portion 61 in the axial direction. The lower surface of the first projection portion 61 is a flat surface orthogonal to the axial direction, and is in contact with the bottom surface 54c from above.

Herein, in the present example embodiment, as described above, the coil connection portion 72 protrudes radially outward from the holder main body portion 63, and hence a connection operation between the coil connection portion 72 and the coil lead wire 32a can be performed on the radially outer side from the holder main body portion 63. With this, as compared to a case in which the coil connection portion 72 protrudes radially inward from the holder main body portion 63, a larger space for performing the connection operation can easily be secured. Therefore, a jig or the like used for performing the connection operation can be suppressed from being in contact with the bus bar holder 60 and other coil connection portions 72, and a worker or the like can easily perform the connection work. In the present specification, the “worker or the like” includes a worker, an assembly device, or the like that performs each task. Each task may be performed by only a worker, may be performed by only an assembly device, or may be performed by a worker and an assembly device.

When the coil connection portion 72 protrudes radially outward from the holder main body portion 63 as described above, the outer diameter of the holder main body portion 63 is easily reduced as compared to a case in which the coil connection portion 72 protrudes radially inward from the holder main body portion 63. In such a case, for example, it is conceived to provide the bus bar holder 60 with a leg portion extending radially outward from the holder main body portion 63 so that the bus bar holder 60 is supported by the outer insulator portion 53 via the leg portion in the axial direction. However, in such a case, the support of the bus bar holder 60 tends to be unstable. Thus, the bus bar holder 60 may be bent due to its own weight, load, stress, or the like from the outside, and there is a possibility that the position of the bus bar 70 held by the bus bar holder 60 may be deviated. With this, the position of the terminal portion 73 may be deviated, and a problem such as making it difficult to connect the terminal portion 73 to the control device 80 may be caused.

In contrast, according to the present example embodiment, the bus bar holder 60 is positioned relative to the inner insulator portion 52 by inserting at least a portion of the first projection portion 61 into the first recess portion 54, and the bus bar holder 60 is supported by the inner insulator portion 52 in the axial direction. With this, as compared to a case in which the bus bar holder 60 is supported by the outer insulator portion 53 via the leg portion described above in the axial direction while the coil connection portion 72 protrudes radially outward from the holder main body portion 63, the bus bar holder 60 can be supported stably in the axial direction relative to the insulator 50. Therefore, according to the present example embodiment in the motor 100, the bus bar holder 60 can be supported stably.

In the present example embodiment, the first projection portion 61 is in contact with a portion, among the inner surfaces of the first recess portion 54, that is positioned on the lower side, in other words, the bottom surface 54c. Thus, by utilizing the first projection portion 61 inserted into the first recess portion 54, the bus bar holder 60 can be supported by the inner insulator portion 52 in the axial direction. With this, there is no need to provide the other portion of the bus bar holder 60 with a portion for supporting the inner insulator portion 52 in the axial direction, and thus suppressing the complexity of the shape of the bus bar holder 60.

The first projection portion 61 is sandwiched between the pair of side surfaces 54a and 54b, among the inner surfaces of the first recess portion 54, in the circumferential direction. Thus, by inserting the first projection portion 61 into the first recess portion 54, the bus bar holder 60 can be positioned relative to the inner insulator portion 52 in the circumferential direction. In the present example embodiment, the first projection portion 61 is fitted into the first recess portion 54. With this, the bus bar holder 60 can be positioned more suitably relative to the inner insulator portion 52 in the circumferential direction. The first projection portion 61 may be in contact with only one of the pair of side surfaces 54a and 54b, may be in contact with the pair of side surfaces 54a and 54b, or may not be in contact with the pair of side surfaces 54a and 54b.

As described above, in the present example embodiment, the holder main body portion 63 is positioned radially outside the inner insulator portion 52. The first recess portion 54 is opened radially outward. The first projection portion 61 protrudes radially inward from the holder main body portion 63. Thus, the inner insulator portion 52 is positioned on the radially inner side of the holder main body portion 63, and the holder main body portion 63 is positioned in the radial direction at a certain extent relative to the inner insulator portion 52. Meanwhile, the first projection portion 61 can be inserted easily into the first recess portion 54. When the inner insulator portion 52 is positioned on the radially inner side of the holder main body portion 63 as in the present example embodiment, the holder main body portion 63 is arranged to be closer to the coil 32 in the axial direction as compared to a case in which the entire holder main body portion 63 is positioned above the inner insulator portion 52. However, in the present example embodiment, as described above, by providing the lower surface of the holder main body portion 63 with the second recess portion 63a, the holder main body portion 63 can be suppressed from being in contact with the coil 32.

As illustrated in FIG. 2, in the present example embodiment, the plurality of first projection portions 61 are provided with a gap in between in the circumferential direction. The plurality of first projection portions 61 are arranged at an equal interval over the entire circumference in the circumferential direction. In the present example embodiment, three first projection portions 61 are provided. The plurality of first projection portions 61 are inserted into the different first recesses portion 54, respectively. Each of the plurality of first projection portions 61 is inserted into the first recess portion 54, and hence the bus bar holder 60 can be positioned more suitably relative to the inner insulator portion 52. In the present example embodiment, due to the plurality of first projection portions 61, the bus bar holder 60 can be supported more stably relative to the inner insulator portion 52 in the axial direction. The number of the first projection portions 61 is less than the number of the first recess portions 54. Thus, the plurality of first recess portions 54 includes the first recess portion 54 into which the first projection portion 61 is inserted and the first recess portion 54 into which the first projection portion 61 is not inserted.

As illustrated in FIG. 5, the bus bar holder 60 includes the second projection portion 62 that protrudes in the axial direction. The second projection portion 62 protrudes downward from the holder main body portion 63. In the present example embodiment, the second projection portion 62 protrudes downward from the radially inner edge portion of the lower surface of the holder main body portion 63. The second projection portion 62 extends in the circumferential direction. The radially inner surface of the second projection portion 62 is provided at the same position in the radial direction as the radially inner surface of the holder main body portion 63. The radially inner surface of the second projection portion 62 is continuous with the radially inner surface of the holder main body portion 63. In the present example embodiment, the second projection portion 62 is provided at the lower surface of the portion of the holder main body portion 63 to which the first projection portion 61 is provided. The second projection portion 62 is not continuous directly with the first projection portion 61.

As illustrated in FIG. 4, the second projection portion 62 is in contact with the inner insulator portion 52 in the radial direction. Thus, the bus bar holder 60 can be positioned by the second projection portion 62 in the radial direction relative to the inner insulator portion 52. In the present example embodiment, the second projection portion 62 is in contact with the inner insulator portion 52 from the radially outer side. A radially inner surface of the second projection portion 62 is in contact with the radially outer surface of the inner insulator portion 52. More specifically, the radially inner surface of the second projection portion 62 is in contact with a portion of the radially outer surface of the first inner protruding portion 52a, the portion being positioned below the first recess portion 54. A portion of the radially outer surface of the first inner protruding portion 52a, which is in contact with the radially inner surface of the second projection portion 62, includes a portion adjacent to the lower side of the first recess portion 54. The radially inner surface of the second projection portion 62 is a surface that is orthogonal to the radial direction and extends in the circumferential direction.

For example, a portion of the radially inner surface of the holder main body portion 63, which is positioned radially outside the inner insulator portion 52, is in contact with the inner insulator portion 52 in the radial direction. With this, the bus bar holder 60 can be positioned in the radial direction relative to the inner insulator portion 52. However, in such a case, it is necessary to manufacture the radially inner surface of the holder main body portion 63 with high accuracy over a wide range in the circumferential direction, and the manufacturing cost of the bus bar holder 60 may increase. In contrast, the second projection portion 62 is in contact with the inner insulator portion 52 in the radial direction. With this configuration, it is only required to manufacture a portion of the second projection portion 62, which is in contact with the inner insulator portion 52, in other words, only the radially inner surface with high accuracy. An increase in the manufacturing cost of the bus bar holder 60 can be suppressed.

As illustrated in FIG. 3, the dimension of the second projection portion 62 in the circumferential direction is larger than the dimension of the first projection portion 61 in the circumferential direction. Thus, the contact area between the second projection portion 62 and the inner insulator portion 52 can be increased easily. The bus bar holder 60 can be positioned more stably in the radial direction relative to the inner insulator portion 52. The second projection portion 62 protrudes to both sides in the circumferential direction from the first projection portion 61. In the present example embodiment, the center of the second projection portion 62 in the circumferential direction is provided at the same position in the circumferential direction as the center of the first projection portion 61 in the circumferential direction.

As illustrated in FIG. 4, the radially outer surface of the second projection portion 62 includes an inclined portion 62a that is positioned on the radially inner side toward the lower side. Thus, a lower portion of the radially outer surface of the second projection portion 62, which is close to the coil 32, can be positioned on the radially inner side. The second projection portion 62 and the coil 32 can be suppressed from being in contact with each other. Therefore, the bus bar holder 60 can be suppressed from floating upward even when the second projection portion 62a abuts against the coil 32 in the axial direction, and the first projection portion 61 can be suppressed from failing to be in contact with the bottom surface 54c of the first recess portion 54. Thus, the bus bar holder 60 can be supported more suitably by the inner insulator portion 52 via the first projection portion 61 in the axial direction. When the inner insulator portion 52 is positioned on the radially inner side of the holder main body portion 63 as in the present example embodiment, the second projection portion 62 tends to be arranged closer to the coil 32. However, in the present example embodiment, by providing the radially outer surface of the second projection portion 62 with the inclined portion 62a, the second projection portion 62 can suitably be suppressed from being in contact with the coil 32. In the present example embodiment, the inclined portion 62a is a lower portion of the radially outer surface of the second projection portion 62. In the present example embodiment, the inclined portion 62a is a curved surface that protrudes radially outward and downward.

As illustrated in FIG. 2, the plurality of second projection portions 62 are provided with a gap in between in the circumferential direction. The plurality of second projection portions 62 are arranged at an equal interval over the entire circumference in the circumferential direction. In the present example embodiment, three second projection portions 62 are provided. The plurality of second projection portions 62 are in contact with the radially outer surfaces of the different inner wall portions 52p, respectively. The second projection portion 62 is provided for each first projection portion 61.

Hereinafter, example embodiments different from the example embodiments described above are described. In the following description of each example embodiment, components similar to those described above in the description of each embodiment are denoted as appropriate by the same reference signs and the like, and description thereof may be omitted. In addition, portions in the example embodiments that correspond to the respective portions of the configuration described above are denoted by the same names and different reference signs, points differing from the configurations described above are described, and a description of points similar to those in the configuration described above may be omitted. Configurations similar to those described above in each example embodiment can be adopted as configurations for which description is omitted in each of the example embodiments below, as long as no contradiction arises.

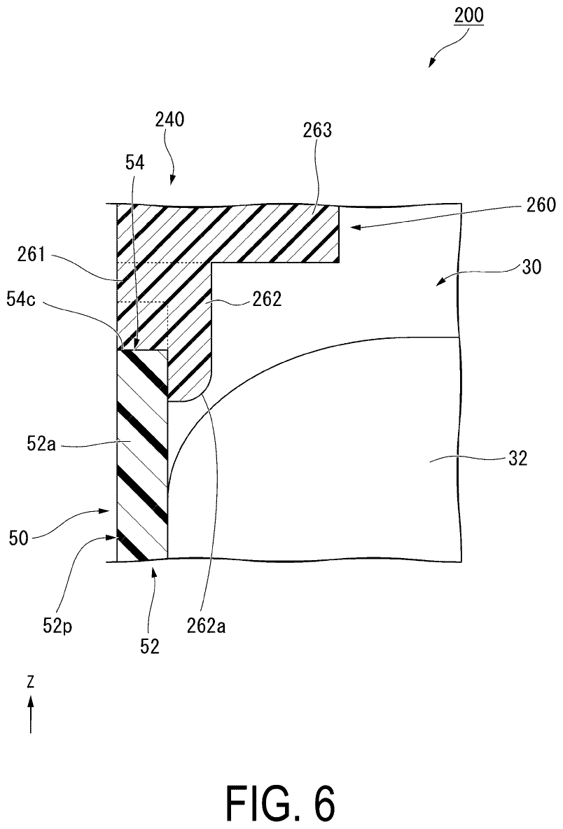

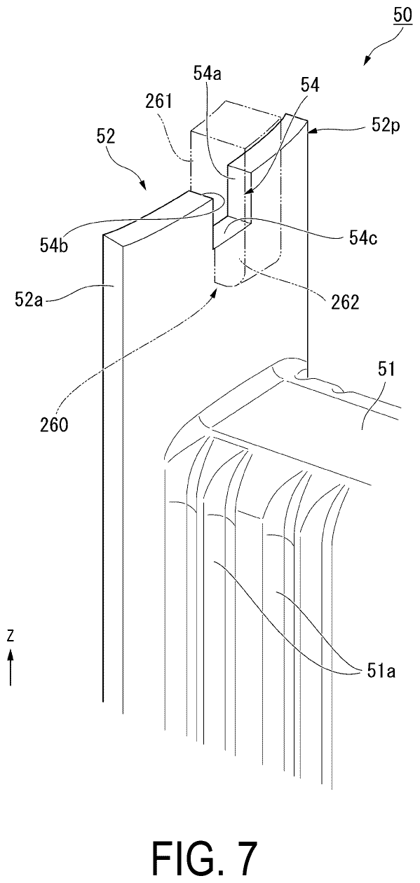

As illustrated in FIGS. 6 and 7, in a bus bar assembly 240 of a motor 200 of a second example embodiment, a bus bar holder 260 includes a first projection portion 261 and a second projection portion 262. In the present example embodiment, the first projection portion 261 protrudes downward from a holder main body portion 263. More specifically, the first projection portion 261 protrudes downward from the radially inner edge portion of the lower surface of the holder main body portion 263. The holder main body portion 263 is similar to the holder main body portion 63 of the first example embodiment, except that the second recess portion 63a is not provided. The radially inner surface of the first projection portion 261 is provided at the same position in the radial direction as the radially inner surface of the holder main body portion 263. The radially inner surface of the first projection portion 261 is continuous with the radially inner surface of the holder main body portion 263.

The first projection portion 261 has a substantially rectangular parallelepiped shape extending in the axial direction. At least a portion of the first projection portion 261 is inserted into the first recess portion 54. In the present example embodiment, the lower portion of the first projection portion 261 is inserted into the first recess portion 54. The upper portion of the first projection portion 261 is positioned above the first recess portion 54. The lower surface of the first projection portion 261 is in contact with the bottom surface 54c of the first recess portion 54. With this, the bus bar holder 260 is supported by the inner insulator portion 52 in the axial direction.

The second projection portion 262 protrudes downward from the holder main body portion 263. The second projection portion 262 is positioned radially outside the first projection portion 261. The second projection portion 262 is continuous with the radially outer surface of the first projection portion 261. The second projection portion 262 has a substantially rectangular parallelepiped shape extending in the axial direction. The second projection portion 262 protrudes to the lower side from the first projection portion 261. As illustrated in FIG. 7, in the present example embodiment, the dimension of the second projection portion 262 in the circumferential direction is the same as the dimension of the first projection portion 261 in the circumferential direction. A portion of the second projection portion 262, which is positioned below the first projection portion 261, is in contact with the inner insulator portion 52 from the radially outer side. In the present example embodiment, the second projection portion 262 is in contact with a portion of the radially outer surface of the first inner protruding portion 52a, the portion being adjacent to the lower side of the first recess portion 54. As illustrated in FIG. 6, the second projection portion 262 includes an inclined portion 262a similarly to the first example embodiment. The inclined portion 262a is provided at the radially outer surface of the second projection portion 262, which corresponds to a portion positioned below the first projection portion 261. Other configurations of the inclined portion 262a are similar to other configurations of the inclined portion 62a in the first example embodiment.

Other configurations of the bus bar assembly 240 are similar to other configurations of the bus bar assembly 40 in the first example embodiment. Other configurations of the motor 200 are similar to other configurations of the motor 100 in the first example embodiment.

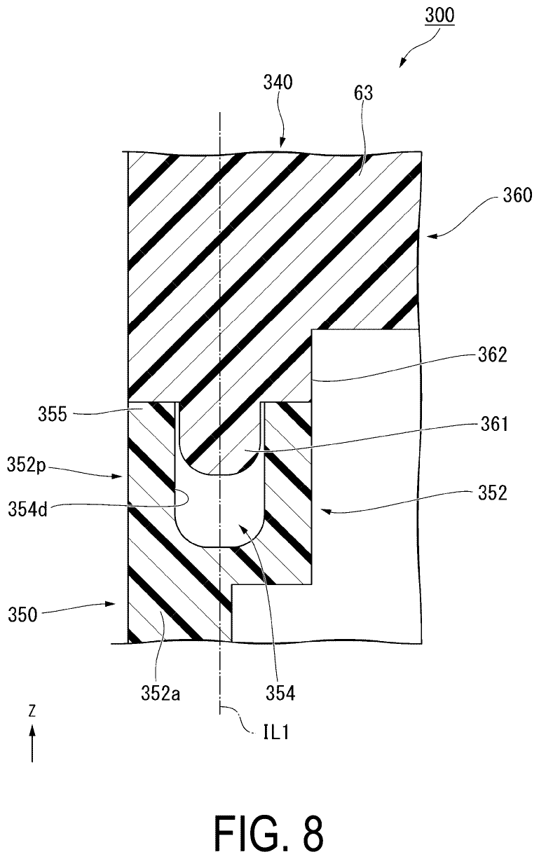

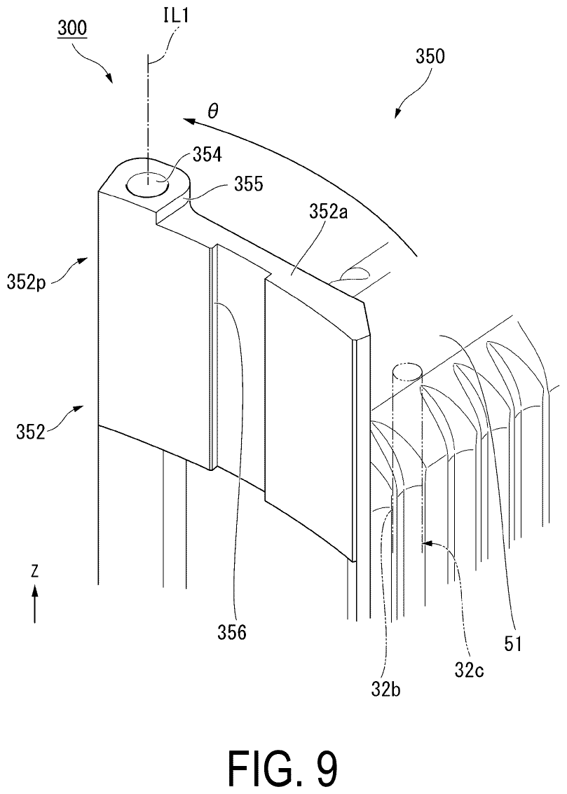

As illustrated in FIGS. 8 and 9, in a motor 300 of a third example embodiment, an inner insulator portion 352 of an insulator 350 includes a third projection portion 355 that protrudes in the axial direction. The third projection portion 355 is provided at an inner wall portion 352p. In the present example embodiment, the third projection portion 355 protrudes upward from an upper surface of a first inner protruding portion 352a. As illustrated in FIG. 9, the third projection portion 355 is provided at a portion of the inner wall portion 352p, the portion being positioned on the one circumferential side from the center of the inner wall portion 352p in the circumferential direction. In the present example embodiment, the third projection portion 355 is provided at the end portion of the upper surface of the first inner protruding portion 352a on the one circumferential side. The third projection portion 355 has a substantially rectangular shape as viewed in the axial direction. The upper surface of the third projection portion 355 is orthogonal to the axial direction.

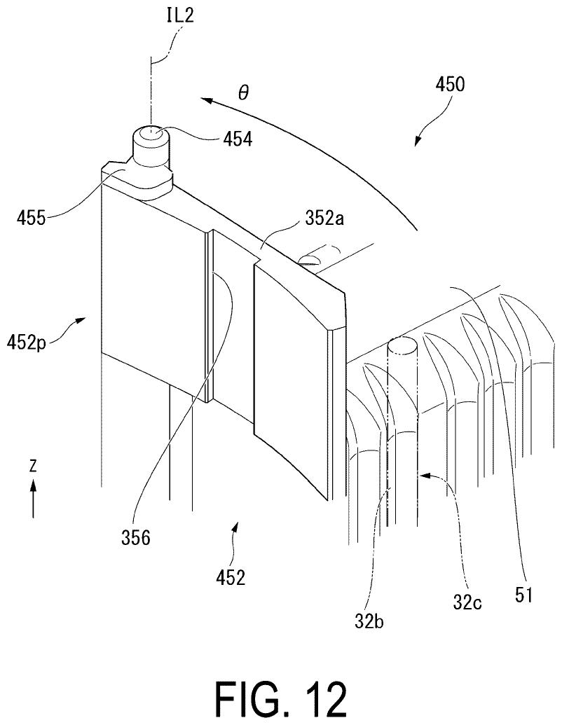

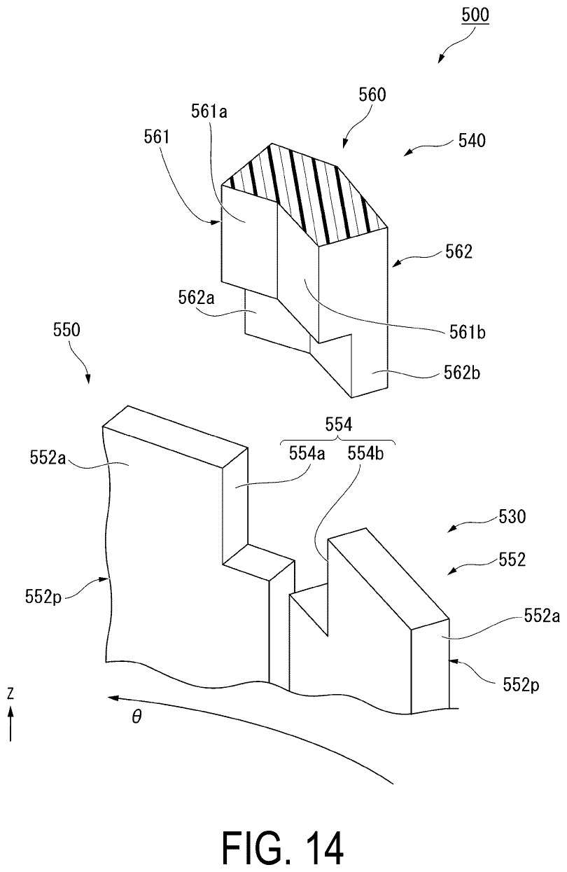

In the present example embodiment, the one circumferential side is a side that proceeds counterclockwise about the center axis line J as viewed from above. In FIG. 9, FIG. 12, which is described below, and FIG. 14, which is described below, the circumferential direction is indicated with the arrow θ. In the present example embodiment, the one circumferential side corresponds to a side (+θ side) to which the arrow θ faces. A side (−θ side) opposite to the side to which the arrow θ points corresponds to the other circumferential side.

As illustrated in FIGS. 8 and 9, the inner insulator portion 352 includes a first recess portion 354. In the present example embodiment, the first recess portion 354 provided at the inner insulator portion 352 is provided at a portion of the inner wall portion 352p, the portion being positioned on the one circumferential side from the center of the inner wall portion 352p in the circumferential direction. In order to increase a space factor of the coil 32, the center portion of the inner wall portion 352p in the circumferential direction tends to be reduced in thickness in the radial direction as compared to both end portions of the inner wall portion 352p in the circumferential direction. In other words, a portion of the inner wall portion 352p, which is deviated in the circumferential direction from the center portion thereof in the circumferential direction, tends to increase in thickness in the radial direction as compared to the center portion of the inner wall portion 352p in the circumferential direction. Thus, the first recess portion 354 is provided at a portion of the inner wall portion 352p, the portion being positioned on the one circumferential side from the center of the inner wall portion 352p in the circumferential direction. With this, the first recess portion 354 is easily provided at a portion having relatively large radial dimension in the inner wall portion 352p. Even when the first projection portion 361 is inserted into the first recess portion 354, and a force is applied from a first projection portion 361 to the inner surface of the first recess portion 354, the force can easily be received by a portion with relatively high rigidity in the inner wall portion 352p. Therefore, due to the inner wall portion 352p, a bus bar holder 360 can be supported more stably.

In the present example embodiment, the first recess portion 354 is provided at a portion of the inner wall portion 352p, the portion including the third projection portion 355. The first recess portion 354 is a hole that is recessed downward and includes a bottom portion on the lower side. The first recess portion 354 is opened in the end surface of the third projection portion 355 in the axial direction. In the present example embodiment, the first recess portion 354 is opened in the upper end surface of the third projection portion 355. The first recess portion 354 has a circular shape as viewed in the axial direction. In the present example embodiment, the radial dimension of the portion of the inner wall portion 352p to which the first recess portion 354 is provided is larger than the radial dimension of the other portion of the inner wall portion 352p. A portion of the inner wall portion 352p to which the first recess portion 354 is provided protrudes to the radial outer side from the other portions of the inner wall portion 352p.

As illustrated in FIG. 8, the inner surface of the first recess portion 354 includes a circumferential surface 354d surrounding the first projection portion 361 about an imaginary axis line IL1 extending in the axial direction. Thus, by inserting the first projection portion 361 into the first recess portion 354, the bus bar holder 360 can be positioned in the radial direction and the circumferential direction relative to the inner insulator portion 352. The imaginary axis line IL1 passes through the center of the first recess portion 354 having a circular shape as viewed in the axial direction. In the present example embodiment, the circumferential surface 354d is a cylindrical surface centered on the imaginary axis line IL1. The circumferential surface 354d is an inner circumferential surface of the first recess portion 354.

As illustrated in FIG. 9, in the center portion of the radially inner surface of the inner wall portion 352p in the circumferential direction, a groove 356 extending in the axial direction is provided. Thus, even when, in molding the insulator 350 using a mold, sink marks occur in the inner wall portion 352p and the inner wall portion 352p is warped, it is possible to suppress the center portion of the inner wall portion 352p in the circumferential direction from being in contact with the rotor 20 positioned radially inside the stator 30. When the groove 356 is provided, the radial dimension of the center portion of the inner wall portion 352p in the circumferential direction is reduced. Thus, in the configuration in which the groove 356 is provided, by arranging the first recess portion 354 described above deviated in the circumferential direction from the center portion of the inner wall portion 352p in the circumferential direction, the effect can be exerted more advantageously.

In the present example embodiment, the radial dimension of the inner wall portion 352p is smallest in a portion of the inner wall portion 352p in the circumferential direction in which the groove 356 is provided. A portion of the inner wall portion 352p that is adjacent to both sides of the groove 356 in the circumferential direction has a radial dimension that increases as the portion is located away from the groove 356 in the circumferential direction.

In the present example embodiment, an end portion 32b at a start of winding a conducting wire 32c forming the coil 32 is positioned on the other circumferential side (−θ side) from the center of the inner wall portion 352p in the circumferential direction. In other words, the end portion 32b at the start of winding is positioned on a side opposite to the first recess portion 354 in the circumferential direction across the center of the inner wall portion 352p in the circumferential direction. Thus, by providing the first recess portion 354, even when the portion of the inner wall portion 352p on the one circumferential side (+θ side) increases in thickness in the radial direction, the thickened portion is unlikely to interfere when the conducting wire 32c is started to be wound. Therefore, a worker or the like can wind the conducting wire 32c easily.

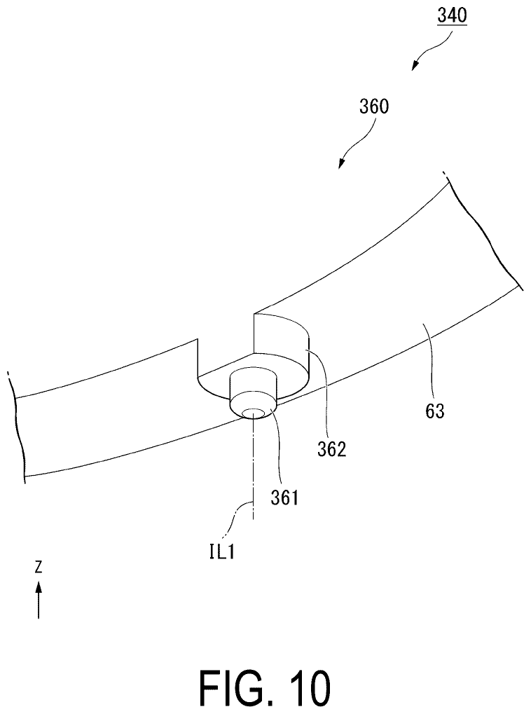

As illustrated in FIG. 10, in a bus bar assembly 340 in the present example embodiment, the bus bar holder 360 includes the first projection portion 361 and a second projection portion 362. The second projection portion 362 protrudes in the axial direction. In the present example embodiment, the second projection portion 362 protrudes downward from the lower surface of the holder main body portion 63. The second projection portion 362 has a shape obtained by cutting out, along the radially inner edge portion of the holder main body portion 63, a radially inner edge portion of a circle centered on the imaginary axis line IL1 as viewed in the axial direction. In a direction orthogonal to the axial direction, the dimension of the second projection portion 362 is larger than that of the first projection portion 361. The outer diameter of the second projection portion 362 is larger than the outer diameter of the first projection portion 361.

As illustrated in FIG. 8, the lower surface of the second projection portion 362 is in contact with the upper surface of the third projection portion 355. With this, the second projection portion 362 is in contact with the inner insulator portion 352 in the axial direction. Therefore, the bus bar holder 360 can be positioned in the axial direction relative to the inner insulator portion 352 via the second projection portion 362. Further, the third projection portion 355 is provided at a portion of the inner wall portion 352p, the portion being positioned on the one circumferential side (+θ side) from the center of the inner wall portion 352p in the circumferential direction. Thus, in a portion whose radial dimension increases easily as compared to the center portion of the inner wall portion 352p in the circumferential direction, the second projection portion 362 can be supported in the axial direction. With this, the load of the bus bar holder 360 can be received stably by the inner wall portion 352p, and the bus bar holder 360 can be supported more stably relative to the inner insulator portion 352.

The first projection portion 361 protrudes in the axial direction from the end portion of the second projection portion 362 in the axial direction. In the present example embodiment, the first projection portion 361 protrudes downward from the lower end surface of the second projection portion 362. As illustrated in FIG. 10, in the present example embodiment, the first projection portion 361 has a substantially columnar shape centered on the imaginary axis line IL1. In the radial direction centered on the imaginary axis line IL1, the outer surface of the first projection portion 361 is located radially inward of the outer surface of the second projection portion 362 to the inner side. As illustrated in FIG. 8, at least a portion of the first projection portion 361 is inserted into the first recess portion 354. In the present example embodiment, the entire first projection portion 361 is inserted into the first recess portion 354. The first projection portion 361 is fitted into the first recess portion 354. For example, the first projection portion 361 is clearance-fitted into the first recess portion 354. An outer circumferential surface of the first projection portion 361 may be in contact with the circumferential surface 354d of the first recess portion 354, or may face the circumferential surface 354d via a gap. The first projection portion 361 may be press-fitted into the first recess portion 354.

In the present example embodiment, the first projection portion 361 protrudes in the axial direction from the end portion of the second projection portion 362 in the axial direction. The inner insulator portion 352 includes the third projection portion 355 that protrudes in the axial direction. The first recess portion 354 is opened in the end surface of the third projection portion 355 in the axial direction. The second projection portion 362 is in contact with the end surface of the third projection portion 355 in the axial direction. Thus, as compared to a case in which the first projection portion 361 and the second projection portion 362 are formed at different locations, it is easier to form the first projection portion 361 and the second projection portion 362. Further, the first recess portion 354 is opened in the end surface of the third projection portion 355 in the axial direction. Thus, the first projection portion 361 can be inserted into the first recess portion 354, and the second projection portion 362 can be in contact with the circumferential edge portion of the first recess portion 354 of the end surface of the third projection portion 355 in the axial direction. With this, the first projection portion 361 is inserted into the first recess portion 354, the bus bar holder 360 is positioned in the circumferential direction and the radial direction, and the second projection portion 362 is in contact with the third projection portion 355. In this manner, the bus bar holder 360 can be positioned easily in the axial direction. Therefore, the bus bar holder 360 can be positioned easily relative to the inner insulator portion 352. Further, the third projection portion 355 is provided as a portion with which the second projection portion 362 contacts. With this, as long as the third projection portion 355 is manufactured with high accuracy, the bus bar holder 360 can be positioned with high accuracy in the axial direction via the second projection portion 362. Therefore, for example, as compared to a case in which the entire upper surface of the first inner protruding portion 352a is manufactured with high accuracy, the number of steps of manufacturing the insulator 350 can be reduced. With this, the manufacturing cost of the motor 300 can be reduced.

The dimension of the first projection portion 361 in the axial direction is smaller than the dimension of the first recess portion 354 in the axial direction. The lower end of the first protruding portion 361 is provided above and spaced apart from a portion of the inner surface of the first recess portion 354, the portion being positioned on the lower side. Other configurations of the bus bar assembly 340 are similar to other configurations of the bus bar assembly 40 in the first example embodiment. Other configurations of the motor 300 are similar to other configurations of the motor 100 in the first example embodiment.

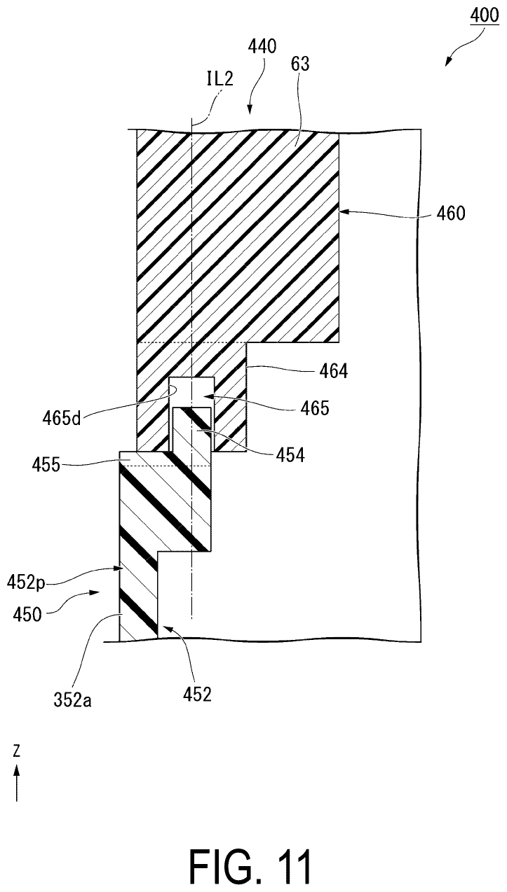

As illustrated in FIG. 11, in an insulator 450 of a motor 400 in a fourth example embodiment, an inner insulator portion 452 includes a first projection portion 454 and a second projection portion 455. The second projection portion 455 is provided at an inner wall portion 452p. In the present example embodiment, the second projection portion 455 protrudes upward from the upper surface of the first inner protruding portion 352a. As illustrated in FIG. 12, the second projection portion 455 is provided at a portion of the inner wall portion 452p, the portion being positioned on the one circumferential side (+θ side) from the center of the inner wall portion 452p in the circumferential direction. In the present example embodiment, the second projection portion 455 is provided at the end portion of the upper surface of the first inner protruding portion 352a on the one circumferential side. The upper surface of the second projection portion 455 is orthogonal to the axial direction.

The first projection portion 454 protrudes in the axial direction from the end portion of the second projection portion 455 in the axial direction. In the present example embodiment, the first projection portion 454 protrudes upward from the radially outer end portion of the upper end surface of the second projection portion 455. The first projection portion 454 has a substantially columnar shape.

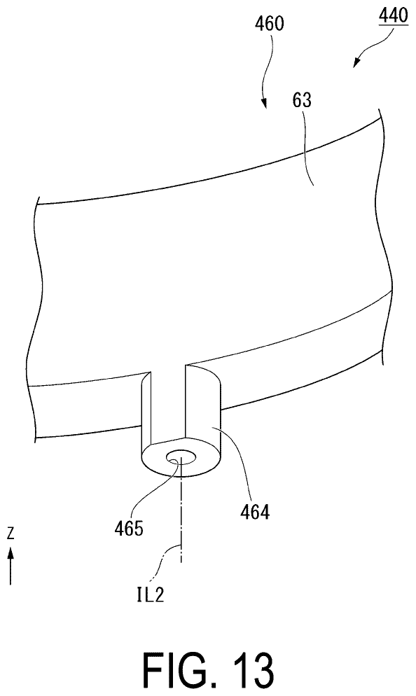

As illustrated in FIG. 13, a bus bar holder 460 of a bus bar assembly 440 includes a third projection portion 464 that protrudes in the axial direction. The third projection portion 464 protrudes downward from the lower surface of the holder main body portion 63. The third projection portion 464 has a substantially circular shape as viewed in the axial direction. In the third projection portion 464, a first recess portion 465 that is recessed upward from the lower surface of the third projection portion 464 is provided. In other words, in the present example embodiment, the first recess portion 465 is opened in the lower end surface of the third projection portion 464. The first recess portion 465 is a hole that is recessed upward and includes a bottom portion on the upper side. The first recess portion 465 has a circular shape as viewed in the axial direction. As illustrated in FIG. 11, the inner surface of the first recess portion 465 includes a circumferential surface 465d surrounding the first projection portion 454 about an imaginary axis line IL2 extending in the axial direction. Thus, by inserting the first projection portion 454 into the first recess portion 465, the bus bar holder 460 can be positioned in the radial direction and the circumferential direction relative to the inner insulator portion 452. The imaginary axis line IL2 passes through the center of the first recess portion 465 having a circular shape as viewed in the axial direction. In the present example embodiment, the circumferential surface 465d is a cylindrical surface centered on the imaginary axis line IL2. The circumferential surface 465d is an inner circumferential surface of the first recess portion 465.

At least a portion of the first projection portion 454 is inserted into the first recess portion 465. In the present example embodiment, the entire first projection portion 454 is inserted into the first recess portion 465. The first projection portion 454 is fitted into the first recess portion 465. For example, the first projection portion 454 is clearance-fitted into the first recess portion 465. An outer circumferential surface of the first projection portion 454 may be in contact with the circumferential surface 465d of the first recess portion 465, or may face the circumferential surface 465d via a gap. The first projection portion 454 may be press-fitted into the first recess portion 465.

The dimension of the first projection portion 454 in the axial direction is smaller than the dimension of the first recess portion 465 in the axial direction. The upper end portion of the first projection portion 454 is provided below and spaced apart from a portion of the inner surface of the first recess portion 465, the portion being positioned on the upper side. The lower end surface of the third projection portion 464 to which the first recess portion 465 is provided is in contact with the upper end surface of the second projection portion 455. With this, the second projection portion 455 is in contact with the bus bar holder 460, which is provided with the first recess portion 465, in the axial direction.

Other configurations of the bus bar assembly 440 are similar to other configurations of the bus bar assembly 40 in the first example embodiment. Other configurations of the motor 400 are similar to other configurations of the motor 100 in the first example embodiment.

According to the present example embodiment, the inner insulator portion 452 includes the first projection portion 454, and the bus bar holder 460 includes the first recess portion 465. Thus, as compared to a case in which the inner insulator portion 452 is provided with the first recess portion 465, generation of a thin portion in the inner insulator portion 452 can be suppressed. With this, the strength of the inner insulator portion 452 can be secured easily, and the bus bar assembly 440 can be supported suitably by the inner insulator portion 452. Further, a thin portion can be suppressed from being provided in the inner insulator portion 452, and hence a resin can be prevented from failing to flow inside a mold when molding the insulator 450 using the mold. With this, the yield of the insulator 450 can be improved.

As illustrated in FIG. 14, in a stator 530 of a motor 500 in a fifth example embodiment, a first recess portion 554 provided at an inner insulator portion 552 of an insulator 550 extends across the inner wall portions 552p are adjacent to each other in the circumferential direction. Thus, in the first recess portion 554, a load of the bus bar holder 560 received via the first projection portion 561 can be received in a dispersed manner by the two inner wall portions 552p. With this, the bus bar holder 560 can be supported more stably.

The first recess portion 554 is recessed downward, and passes in the radial direction through the inner wall portions 552p adjacent to each other in the circumferential direction. The first recess portion 554 includes a first portion 554a and a second portion 554b. Of the inner wall portions 552p adjacent to each other in the circumferential direction, the first portion 554a is provided at the inner wall portion 552p positioned on the one circumferential side (+θ side). Of the inner wall portions 552p adjacent to each other in the circumferential direction, the second portion 554b is provided at the inner wall portion 552p positioned on the other circumferential side (−θ side). The first portion 554a is provided at an end portion of the first inner protruding portion 552a on the other circumferential side in the inner wall portion 552p positioned on the one circumferential side, and passes through the first inner protruding portion 552a in the radial direction. The second portion 554b is provided at an end portion of the first inner protruding portion 552a on the one circumferential side in the inner wall portion 552p positioned on the other circumferential side, and passes through the first inner protruding portion 552a in the radial direction.

Similarly to the first projection portion 261 and the second projection portion 262 of the second example embodiment, the first projection portion 561 and a second projection portion 562 that are provided at the bus bar holder 560 of a bus bar assembly 540 protrude downward from the lower surface of the holder main body portion 63. The first projection portion 561 includes a first portion 561a and a second portion 561b. The first portion 561a is positioned on the one circumferential side (+θ side) of the second portion 561b, and is continuous with the second portion 561b. The first portion 561a is inserted into the first portion 554a of the first recess portion 554 from above. The second portion 561b is inserted into the second portion 554b of the first recess portion 554 from above. The first portion 561a of the first projection portion 561 is in contact with the lower surface of the first portion 554a of the first recess portion 554 from above. The second portion 561b of the first projection portion 561 is in contact with the lower surface of the second portion 554b of the first recess portion 554 from above.

The second projection portion 562 includes a first portion 562a and a second portion 562b. The first portion 562a is in contact with the inner wall portion 552p positioned on the one circumferential side (+θ side) from the radially outer side. The second portion 562b is in contact with the inner wall portion 552p positioned on the other circumferential side (−θ side) from the radially outer side. Other configurations of the bus bar assembly 540 are similar to other configurations of the bus bar assembly 240 in the second example embodiment. Other configurations of the motor 500 are similar to other configurations of the motor 200 in the second example embodiment.

The present disclosure is not limited to the example embodiments described above, and other configurations and other methods can be adopted within the scope of the technical idea of the present disclosure. The shape of the first recess portion is not particularly limited. The first projection portion may have any shape as long as at least a portion thereof is inserted into the first recess portion. The direction in which the first recess portion is recessed is not particularly limited. The first recess portion may be a recess portion that is recessed in a direction other than the axial direction. The direction in which the first projection portion protrudes is not particularly limited. In each of the first example embodiment, the second example embodiment, and the fifth example embodiment described above, the first projection portion and the second projection portion may be provided at the inner insulator portion, and the first recess portion may be provided at the bus bar holder. The number of the first projection portions and the number of the first recess portions are not particularly limited as long as one or more first projection portions and one or more first recess portions are provided. The number of the second projection portions is not particularly limited as long as one or more second projection portions are provided. The second projection portion may not be provided.

Any portion of the bus bar holder may be in contact with the inner insulator portion as long as the bus bar holder is supported by the inner insulator portion in the axial direction. For example, in the second example embodiment described above, the first projection portion 261 is not in contact with the bottom surface 54c, and the lower surface of the holder main body portion 263 is in contact with the upper end surface of the first inner protruding portion 52a. In this manner, the bus bar holder 260 may be supported by the inner insulator portion 52 in the axial direction. The application of the motors of the example embodiments described above is not particularly limited.

The present technology can have the following configurations.

(1) A motor including a rotor that is rotatable about a center axis line, a stator that is positioned radially outside the rotor, and a bus bar assembly that is positioned on a first axial side of the stator, the stator includes a stator core, an insulator that is attached to the stator core, and a coil that is attached to the stator core via the insulator, the insulator includes an inner insulator portion that is positioned radially inside the coil, the bus bar assembly includes a bus bar, and a bus bar holder that holds the bus bar, the bus bar holder includes a holder main body portion that has an annular shape surrounding the center axis line, the bus bar includes a coil connection portion that is connected to a coil lead wire drawn out from the coil, the coil connection portion protrudes radially outward from the holder main body portion, a portion of one of the inner insulator portion and the bus bar holder includes a first recess portion, a portion of the other of the inner insulator portion and the bus bar holder includes a first projection portion, at least a portion of the first projection portion is inserted into the first recess portion, and the bus bar holder is supported by the inner insulator portion in an axial direction.

(2) The motor according to Item (1), wherein the inner insulator portion includes the first recess portion, the bus bar holder includes the first projection portion, the first recess portion is recessed to a second axial side, and the first projection portion is in contact with a portion of an inner surface of the first recess portion positioned on the second axial side.

(3) The motor according to Item (2), wherein the inner surface of the first recess portion includes a pair of side surfaces that sandwich the first projection portion in a circumferential direction.

(4) The motor according to Item (2) or (3), wherein the holder main body portion is positioned radially outside the inner insulator portion, the first recess portion is opened radially outward, and the first projection portion protrudes radially inward from the holder main body portion.

(5) The motor according to any one of Items (2) to (4), wherein the stator core includes a core back that has an annular shape surrounding the center axis line, and a plurality of teeth that extend radially inward from the core back and are arranged with a gap in between in the circumferential direction, the insulator includes a plurality of insulator piece portions that are attached to the plurality of teeth, respectively, each of the plurality of insulator piece portions includes an inner wall portion that is positioned radially inside the coil, the inner insulator portion includes the inner wall portion of each of the plurality of insulator piece portions, and the first recess portion extends across the inner wall portions that are adjacent to each other in the circumferential direction.

(6) The motor according to Item (1), wherein the inner insulator portion includes the first projection portion, and the bus bar holder includes the first recess portion.

(7) The motor according to Item (1) or (6), wherein the inner surface of the first recess portion includes a circumferential surface that surrounds the first projection portion about an imaginary axis line extending in the axial direction.

(8) The motor according to any one of Items (1) to (4), (6), and (7), wherein the stator core includes a core back that has an annular shape surrounding the center axis line, and a plurality of teeth that extend radially inward from the core back and are arranged with a gap in between in the circumferential direction, the insulator includes a plurality of insulator piece portions that are attached to the plurality of teeth, respectively, each of the plurality of insulator piece portions includes an inner wall portion that is positioned radially inside the coil, the inner insulator portion includes the inner wall portion of each of the plurality of insulator piece portions, and a portion, among the first recess portion and the first projection portion, that is provided at the inner insulator portion is provided at a portion of the inner wall portion that is positioned on a first circumferential side from a center of the inner wall portion in the circumferential direction.

(9) The motor according to Item (8), wherein the coil includes a conducting wire wound around the tooth via the insulator piece portion, and the end portion at a start of winding of the conducting wire is positioned on a second circumferential side from the center of the inner wall portion in the circumferential direction.

(10) The motor according to Item (8) or (9), wherein in a center portion of a radially inner surface of the inner wall portion in the circumferential direction, a groove extending in the axial direction is provided.

(11) The motor according to any one of Items (1) to (10), wherein the other portion includes a second projection portion that protrudes in the axial direction and is in contact with the one portion in a radial direction.

(12) The motor according to Item (11), wherein a dimension of the second projection portion in the circumferential direction is larger than a dimension of the first projection portion in the circumferential direction.

(13) The motor according to Item (11) or (12), wherein the second projection portion protrudes from the holder main body portion to the other axial side, and is in contact with the inner insulator portion from a radially outer side, and a radially outer surface of the second projection portion includes an inclined portion that is positioned on a radially inner side toward the second axial side.

(14) The motor according to any one of Items (1) to (10), wherein the other portion includes a second projection portion that protrudes in the axial direction, and the second projection portion is in contact with the one portion in the axial direction.

(15) The motor according to Item (14), wherein in a direction orthogonal to the axial direction, a dimension of the second projection portion is larger than a dimension of the first projection portion, the first projection portion protrudes in the axial direction from an end portion of the second projection portion in the axial direction, the one portion includes a third projection portion that protrudes in the axial direction, the first recess portion is opened in an end surface of the third projection portion in the axial direction, and the second projection portion is in contact with an end surface of the third projection portion in the axial direction.

(16) The motor according to any one of Items (1) to (15), wherein the holder main body portion faces the coil in the axial direction, and a portion of a surface of the holder main body portion on the second axial side is provided with a second recess portion that is recessed to the first axial side and faces the coil in the axial direction.

The configurations and methods described above in the present specification can be combined as appropriate within a range in which they do not contradict each other.

Features of the above-described example embodiments and the modifications thereof may be combined appropriately as long as no conflict arises.

While example embodiments of the present disclosure have been described above, it is to be understood that variations and modifications apparent to those skilled in the art without departing from the scope and spirit of the present disclosure are included in the present invention. The scope of the present disclosure, therefore, is to be determined solely by the following claims.

What is claimed is:

1. A motor comprising:
a rotor that is rotatable about a center axis line;
a stator that is positioned radially outside the rotor; and
a bus bar assembly that is positioned on a first axial side of the stator;
the stator includes:
a stator core;
an insulator that is attached to the stator core; and
a coil that is attached to the stator core via the insulator; wherein
the insulator includes an inner insulator portion that is positioned radially inside the coil:
the bus bar assembly includes:
a bus bar; and
a bus bar holder that holds the bus bar; wherein
the bus bar holder includes a holder main body portion that has an annular shape surrounding the center axis line;
the bus bar includes a coil connection portion that is connected to a coil lead wire drawn out from the coil;
the coil connection portion protrudes radially outward from the holder main body portion;
a portion of one of the inner insulator portion and the bus bar holder includes a first recess portion;
a portion of the other of the inner insulator portion and the bus bar holder includes a first projection portion;
at least a portion of the first projection portion protrudes into the first recess portion; and
the bus bar holder is supported by the inner insulator portion in an axial direction.

2. The motor according to claim 1, wherein
the inner insulator portion includes the first recess portion;
the bus bar holder includes the first projection portion;
the first recess portion is recessed to a second axial side; and
the first projection portion is in contact with a portion of an inner surface of the first recess portion positioned on the second axial side.

3. The motor according to claim 2, wherein the inner surface of the first recess portion includes a pair of side surfaces that sandwich the first projection portion in a circumferential direction.

4. The motor according to claim 2, wherein
the holder main body portion is positioned radially outside the inner insulator portion;
the first recess portion is opened radially outward; and
the first projection portion protrudes radially inward from the holder main body portion.

5. The motor according to claim 2, wherein the stator core includes:
a core back that has an annular shape surrounding the center axis line; and
a plurality of teeth that extend radially inward from the core back and are arranged with a gap in between in the circumferential direction;
the insulator includes a plurality of insulator piece portions that are attached to the plurality of teeth, respectively;
each of the plurality of insulator piece portions includes an inner wall portion that is positioned radially inside the coil;
the inner insulator portion includes the inner wall portion of each of the plurality of insulator piece portions; and
the first recess portion extends across the inner wall portions that are adjacent to each other in the circumferential direction.

6. The motor according to claim 1, wherein
the inner insulator portion includes the first projection portion; and
the bus bar holder includes the first recess portion.

7. The motor according to claim 1, wherein the inner surface of the first recess portion includes a circumferential surface that surrounds the first projection portion about an imaginary axis line extending in the axial direction.

8. The motor according to claim 1, wherein the stator core includes:
a core back that has an annular shape surrounding the center axis line; and
a plurality of teeth that extend radially inward from the core back and are arranged with a gap in between in the circumferential direction;
the insulator includes a plurality of insulator piece portions that are attached to the plurality of teeth, respectively;
each of the plurality of insulator piece portions includes an inner wall portion that is positioned radially inside the coil;
the inner insulator portion includes the inner wall portion of each of the plurality of insulator piece portions; and
a portion, among the first recess portion and the first projection portion, that is provided at the inner insulator portion is provided at a portion of the inner wall portion that is positioned on a first circumferential side from a center of the inner wall portion in the circumferential direction.

9. The motor according to claim 8, wherein
the coil includes a conducting wire wound around the tooth via the insulator piece portion; and
the end portion at a start of winding of the conducting wire is positioned on a second circumferential side from the center of the inner wall portion in the circumferential direction.

10. The motor according to claim 8, wherein in a center portion of a radially inner surface of the inner wall portion in the circumferential direction, a groove extending in the axial direction is provided.

11. The motor according to claim 1, wherein
the other portion includes a second projection portion that protrudes in the axial direction; and
the second projection portion is in contact with the one portion in a radial direction.

12. The motor according to claim 11, wherein a dimension of the second projection portion in the circumferential direction is larger than a dimension of the first projection portion in the circumferential direction.

13. The motor according to claim 11, wherein
the second projection portion protrudes from the holder main body portion to the other axial side, and is in contact with the inner insulator portion from a radially outer side; and
a radially outer surface of the second projection portion includes an inclined portion that is positioned on a radially inner side toward the other axial side.

14. The motor according to claim 1, wherein
the other portion includes a second projection portion that protrudes in the axial direction; and
the second projection portion is in contact with the one portion in the axial direction.

15. The motor according to claim 14, wherein
in a direction orthogonal to the axial direction, a dimension of the second projection portion is larger than a dimension of the first projection portion,
the first projection portion protrudes in the axial direction from an end portion of the second projection portion in the axial direction,
the one portion includes a third projection portion that protrudes in the axial direction,
the first recess portion is opened in an end surface of the third projection portion in the axial direction, and
the second projection portion is in contact with an end surface of the third projection portion in the axial direction.

16. The motor according to claim 1, wherein
the holder main body portion faces the coil in the axial direction; and
a portion of a surface of the holder main body portion on the second axial side is provided with a second recess portion that is recessed to the first axial side and faces the coil in the axial direction.
